(19) United States
(12) Patent Application Publication
(10) Pub. No.: US 2023/0154324 A1
(43) Pub. Date: May 18, 2023

(54) Computer-Implemented Method and System for Usage-Controlled Service Delivery to an Onboard System of a Vehicle

(71) Applicant: Bayerische Motoren Werke Aktiengesellschaft, Muenchen (DE)

(72) Inventors: Jochen BRAUN, Muenchen (DE); Christian DENICH, Muenchen (DE); Sabrina DENICH, Muenchen (DE); Ulrich MUEHLBAUER, Muenchen (DE)

(21) Appl. No.: 17/920,455

(22) PCT Filed: May 7, 2021
(86) PCT No.: PCT/EP2021/062145

§ 371 Date: Oct. 21, 2022

(30) Foreign Application Priority Data
Jun. 2, 2020 (DE) 10 2020 114 619.1

(51) Int. Cl. G08G 1/0967; G01C 21/36; G01C 21/00; G08G 1/0968

(52) U.S. Cl. CPC G08G 1/096775; G01C 21/3685; G01C 21/3691; G01C 21/3896; G08G 1/096716; G08G 1/096838; G08G 1/096844

(57) ABSTRACT

A computer-implemented method and system for usage-controlled service delivery to an onboard system of a vehicle are designed for delivering updatable services to the onboard system of the vehicle by way of a vehicle-external server according to data of the service usage behavior of a vehicle user of the updatable services.

### BACKGROUND AND SUMMARY

The invention relates to a computer-implemented method for usage-controlled service delivery to an on-board system of a vehicle. The invention furthermore relates to a system for usage-controlled service delivery to an on-board system of a vehicle. The invention furthermore relates to a computer program and to a computer-readable data carrier.

Most vehicle markets are what are known as built-to-stock markets, that is to say the market or the vehicle traders configure and order vehicles, wherein the customers are then able to choose from the options put together by the market. At present, customers receive - resulting from the mandatory coupling of particular components such as for example large displays - navigation without having made a targeted decision to have navigation. In some cases, this results in very low usage rates of the navigation and of the updatable services.

EP 3472560 B1 relates to a method for providing a service over a communication network, wherein, in the method, the communication network is used to access a service server that provides the service for service users.

At present, navigation services such as for example traffic information, including traffic information updates (RTTI), navigation map updates and/or parking space information are delivered independently of the usage of the navigation system.

One disadvantage of this procedure is that it gives rise to high data transmission costs for the vehicle manufacturers or service providers, which in some cases lead to no customer use whatsoever.

There is therefore a need to enable improved service delivery to an on-board system of a vehicle.

The object is achieved by way of a computer-implemented method and system for usage-controlled service delivery to an on-board system and by way of a computer product, in accordance with the independent claims.

The present invention provides a computer-implemented method for usage-controlled service delivery to an on-board system of a vehicle.

The method comprises acquiring data about a service usage behavior of a vehicle user of services provided to the vehicle user by the on-board system and able to be updated by way of a server external to the vehicle, in particular real time-capable and/or location-based services such as navigation services.

The method furthermore comprises transmitting the acquired data about the service usage behavior of the vehicle user of the updatable services to a server external to the vehicle, in particular a cloud server. The method furthermore comprises delivering the updatable services to the on-board system of the vehicle by way of the server external to the vehicle on the basis of the data about the service usage behavior of the vehicle user of the updatable services.

The present invention furthermore provides a system for usage-controlled service delivery to an on-board system of a vehicle. The system comprises means for acquiring data about a service usage behavior of a vehicle user of services provided to the vehicle user by the on-board system and able to be updated by way of a server external to the vehicle, in particular real time-capable and/or location-based services such as navigation services.

The system furthermore comprises means for transmitting the data about the service usage behavior of the vehicle user of the updatable services to a server external to the vehicle, in particular a cloud server. The system furthermore comprises means for delivering the updatable services to the on-board system of the vehicle by way of the server external to the vehicle on the basis of the data about the service usage behavior of the vehicle user of the updatable services.

The present invention furthermore provides a computer program containing program code for performing the method according to the invention when the computer program is executed on a computer.

The present invention furthermore provides a computer-readable data carrier containing program code of a computer program for performing the method according to the invention when the computer program is executed on a computer.

One aspect of the present invention is to optimize data delivery while achieving lower costs and higher customer use by delivering the updatable services to the on-board system of the vehicle by way of the server external to the vehicle on the basis of the data about the service usage behavior of the vehicle user of the updatable services. Data transmission costs that lead to no customer use whatsoever may thus advantageously be saved.

Advantageous embodiments and developments will become apparent from the dependent claims and from the description with reference to the figures.

According to one preferred development, provision is made for the data about the service usage behavior of the vehicle user of the updatable services to be evaluated by the on-board system of the vehicle and/or the server external to the vehicle. Based on the evaluation of the data about the service usage behavior of the vehicle user of the updatable services, usage-controlled data delivery to the on-board system of the vehicle and/or usage-controlled data queries made by the on-board system of the vehicle may thus advantageously be performed.

According to a further preferred development, provision is made for a frequency of the delivery of the updatable services by the server external to the vehicle to the on-board system to be set on the basis of the data evaluated by the on-board system of the vehicle and/or the server external to the vehicle.

Usage-controlled service delivery to the on-board system of the vehicle may thus advantageously take place, wherein the frequency of the delivery of the updatable services is defined by the degree of usage thereof.

According to a further preferred development, provision is made for a frequency of data queries of the updatable services of the on-board system to the server external to the vehicle to be set on the basis of the data evaluated by the on-board system of the vehicle and/or the server external to the vehicle. Especially in the case of evaluating the data by way of the on-board system, the frequency of data queries of the updatable services by the on-board system to the server external to the vehicle may thus be set in a usage-controlled manner.

According to a further preferred development, provision is made for the data about the service usage behavior of the vehicle user of the updatable services to be contained in a data query of the updatable services of the on-board system to the server external to the vehicle. An existing communication structure between the on-board system and the server external to the vehicle may thus advantageously be used to transmit the data about the usage behavior.

According to a further preferred development, provision is made for the data about the service usage behavior of the vehicle user of the updatable services to comprise a service usage acquired over a predefined period and/or an estimated future service usage. The data about the service usage behavior of the vehicle user of the updatable services may thus be historical data or usage data estimated on the basis of historical data or approximated future usage data.

According to a further preferred development, provision is made for the updatable services to comprise traffic information, navigation map updates and/or parking space information. These services, for which data transmission from the server external to the vehicle to the on-board system of the vehicle is expensive, may thus be delivered in a demand-oriented manner.

According to a further preferred development, provision is made for a delivery of the updatable services, in particular an update of navigation map data, by the server external to the vehicle to the on-board system of the vehicle to be prioritized on the basis of the service usage behavior of the vehicle user of the updatable services of the on-board system if a usage frequency of the updatable services exceeds a predefined threshold value.

The updatable services may thus advantageously be delivered with priority to a large number of users, wherein the delayed delivery to infrequent users does not entail any disadvantages whatsoever for the infrequent users in question.

According to a further preferred development, provision is made, if the updatable services are not used for a predefined number of vehicle starts, a predefined operating duration of the vehicle and/or a predefined length of a journey of the vehicle, for the frequency of the delivery of the updatable services by the server external to the vehicle to the on-board system and/or the frequency of the data queries of the updatable services of the on-board system to the server external to the vehicle, in particular to update the updatable services, to be reduced.

Based on the abovementioned parameters, it is thus advantageously possible to achieve usage-controlled delivery of the updatable services or a usage-controlled frequency of data queries.

According to a further preferred development, provision is made for an update radius, in particular a geographical extent covered by the data, of the data of the updatable services around the vehicle and/or covered functional road classes to be adapted on the basis of the acquired data about the service usage behavior of the vehicle user of the updatable services. The vehicle user thus advantageously always receives the data updates that are relevant to him for the updatable services.

According to a further preferred development, provision is made for the used updatable services to be delivered, in particular the used navigation services to be updated, upon each start of a new navigation route. Even infrequent users of the updatable services are thus not able to identify any difference whatsoever in the delivery of the updatable services, since the correspondingly required data are updated upon each start of a new route guidance.

According to a further preferred development, provision is made for the evaluation of the data about the service usage behavior of the vehicle user of the updatable services by the on-board system of the vehicle and/or the server external to the vehicle to comprise a usage duration of a mode in which a navigation map is displayed, a duration for which navigation guidance is used and/or a duration for which a full-screen map mode is used. Evaluating the abovementioned parameters thus advantageously makes it possible to obtain an exact usage behavior of the vehicle user of the updatable services.

The described embodiments and developments may be combined with one another as desired.

Further possible embodiments, developments and implementations of the invention also comprise combinations that are not explicitly mentioned of features of the invention that are described above or below in connection with the exemplary embodiments.

The accompanying drawings are intended to convey a further understanding of the embodiments of the invention. They illustrate embodiments and serve, in connection with the description, to clarify principles and concepts of the invention.

Other embodiments and many of the advantages mentioned will become apparent in view of the drawings. The illustrated elements in the drawings are not necessarily shown to scale in relation to one another.

### BRIEF DESCRIPTION OF THE DRAWINGS

FIG. 1 is a flowchart of a computer-implemented method for usage-controlled service delivery to an on-board system of a vehicle according to one preferred embodiment of the invention; and

FIG. 2 is a schematic illustration of a system for usage-controlled service delivery to the on-board system of the vehicle according to the preferred embodiment of the invention.

### DETAILED DESCRIPTION OF THE DRAWINGS

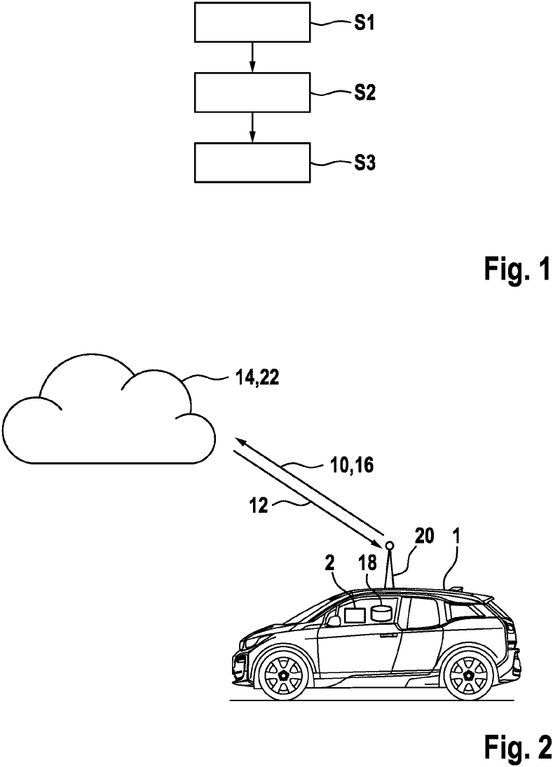

The method shown in FIG. 1 comprises a computer-implemented method for usage-controlled service delivery to an on-board system 2 of a vehicle 1.

The method comprises acquiring S1 data 10 about a service usage behavior of a vehicle user of services 12 provided to the vehicle user by the on-board system 2 and able to be updated by way of a server 14 external to the vehicle, in particular real time-capable and/or location-based services such as navigation services 12.

The method furthermore comprises transmitting S2 the acquired data 10 about the service usage behavior of the vehicle user of the updatable services 12 to a server 14 external to the vehicle, in particular a cloud server.

The method furthermore comprises delivering S3 the updatable services 12 to the on-board system 2 of the vehicle 1 by way of the server 14 external to the vehicle on the basis of the data 10 about the service usage behavior of the vehicle user of the updatable services 12.

FIG. 2 shows a schematic illustration of a system for usage-controlled service delivery to the on-board system of the vehicle according to the preferred embodiment of the invention.

The system comprises one or more devices 18 for acquiring data 10 about a service usage behavior of a vehicle user of updatable services 12 of the on-board system 2.

The system comprises a device 20 for transmitting the data 10 about the service usage behavior of the vehicle user of the updatable services 12 to a server 14 external to the vehicle, in particular a cloud server 14.

The system comprises a device 22 for delivering the updatable services 12 to the on-board system 2 of the vehicle 1 by way of the server 14 external to the vehicle on the basis of the data 10 about the service usage behavior of the vehicle user of the updatable services 12.

The data 10 about the service usage behavior of the vehicle user of the updatable services 12 are preferably evaluated by the server 14 external to the vehicle. As an alternative or in addition, the data 10 about the service usage behavior of the vehicle user of the updatable services 12 may be evaluated by the on-board system 2 of the vehicle 1.

A frequency of the delivery of the updatable services 12 by the server 14 external to the vehicle to the on-board system 2 is set on the basis of the data 10 evaluated by the on-board system 2 of the vehicle 1 and/or the server 14 external to the vehicle.

Furthermore, a frequency of data queries 16 of the updatable services 12 of the on-board system 2 to the server 14 external to the vehicle is set on the basis of the data 10 evaluated by the on-board system 2 of the vehicle 1 and/or the server 14 external to the vehicle.

The data 10 about the service usage behavior of the vehicle user of the updatable services 12 are contained in a data query 16 of the updatable services 12 of the on-board system 2 to the server 14 external to the vehicle. The data 10 about the service usage behavior of the vehicle user of the updatable services 12 comprise a service usage acquired over a predefined period and/or an estimated future service usage.

The updatable services 12 comprise navigation services such as traffic information such as for example RTTI, navigation map updates and/or parking space information.

The abovementioned services are provided to the vehicle user by the on-board system 2 of the vehicle 1, wherein the on-board system 2 takes updates to the services from the server 14 external to the vehicle.

A delivery of the updatable services 12, in particular an update of navigation map data 10, by the server 14 external to the vehicle to the on-board system 2 of the vehicle 1 is prioritized on the basis of the service usage behavior of the vehicle user of the updatable services 12 of the on-board system 2 if a usage frequency of the updatable services 12 exceeds a predefined threshold value.

If the updatable services 12 are not used for a predefined number of vehicle starts, a predefined operating duration of the vehicle 1 and/or a predefined length of a journey of the vehicle 1, the frequency of the delivery of the updatable services 12 by the server 14 external to the vehicle to the on-board system 2 and/or the frequency of data queries 16 of the updatable services 12 of the on-board system 2 to the server 14 external to the vehicle, in particular to update the updatable services 12, is reduced.

An update radius, in particular a geographical extent covered by the data 10, of the data 10 of the updatable services 12 around the vehicle 1 and/or covered functional road classes is adapted on the basis of the acquired data 10 about the service usage behavior of the vehicle user of the updatable services 12.

The used updatable services 12 are delivered, in particular the used updatable services 12 are updated, upon each start of a new navigation route.

The evaluation of the data 10 about the service usage behavior of the vehicle user of the updatable services 12 by the on-board system 2 of the vehicle 1 and/or the server 14 external to the vehicle comprises a usage duration of a mode in which a navigation map is displayed, a duration for which navigation guidance is used and/or a duration for which a full-screen map mode is used.

The term vehicle encompasses automobiles, trucks, buses, RVs, motorcycles etc. that are used to transport people, goods, etc.

The term in particular encompasses motor vehicles for transporting people. In addition or as an alternative, a hybrid or electric vehicle according to some embodiments may be a fully electric vehicle (BEV) or a plug-in hybrid vehicle (PHEV). However, other forms of drive may also be used, for example in the form of a diesel-operated or petrol-operated vehicle. The vehicle may also be present in the form of a rail vehicle.

Although the invention has been described and illustrated in more detail using preferred exemplary embodiments, the invention is not restricted by the disclosed examples and other variations may be derived therefrom by a person skilled in the art without departing from the scope of protection of the invention.

It is therefore clear that a large number of variation options exist. By way of example, said embodiments constitute only examples that should not in any way be understood as limiting for instance the scope of protection, the application options or the configuration of the invention.

On the contrary, the above description and the description of the figures give a person skilled in the art the ability to implement the exemplary embodiments in concrete terms, wherein a person skilled in the art aware of the disclosed concept of the invention is able to make many modifications for example with regard to the function or the arrangement of some of the elements mentioned in one exemplary embodiment without departing from the scope of protection that is defined by the claims and their legal counterparts, such as for instance further explanations in the description.

The updatable services 12 are delivered S3 in the present embodiment by the server 14 external to the vehicle to the on-board system 2 of the vehicle 1 on the basis of the data 10 about the service usage behavior of the vehicle user of the updatable services 12.

As an alternative, the updatable services 12 may be delivered S3, for example, to a server internal to the vehicle by the server 14 external to the vehicle. The server 14 external to the vehicle is connected to the on-board system 2 by a wireless network, for example.

The data about the service usage behavior of a vehicle user are preferably not only incorporated, but rather likewise recorded by the on-board system 2 of the vehicle 1.

1-15. (canceled)

16. A computer-implemented method for usage-controlled service delivery to an on-board system of a vehicle, comprising:
acquiring data about a service usage behavior of a vehicle user of updatable services of the on-board system;
transmitting the acquired data about the service usage behavior of the vehicle user of the updatable services to a server external to the vehicle; and
delivering the updatable services to the on-board system of the vehicle by way of the server external to the vehicle on the basis of the acquired data about the service usage behavior of the vehicle user of the updatable services.

17. The computer-implemented method according to claim 16, wherein
the data about the service usage behavior of the vehicle user of the updatable services are evaluated by the on-board system of the vehicle and/or the server external to the vehicle.

18. The computer-implemented method according to claim 17, wherein
a frequency of the delivery of the updatable services by the server external to the vehicle to the on-board system is set on the basis of the data evaluated by the on-board system of the vehicle and/or the server external to the vehicle.

19. The computer-implemented method according to claim 18, wherein
a frequency of data queries of the updatable services of the on-board system to the server external to the vehicle is set on the basis of the data evaluated by the on-board system of the vehicle and/or the server external to the vehicle.

20. The computer-implemented method according to claim 19, wherein
the data about the service usage behavior of the vehicle user of the updatable services are contained in a data query of the updatable services of the on-board system to the server external to the vehicle.

21. The computer-implemented method according to claim 16, wherein
the data about the service usage behavior of the vehicle user of the updatable services comprise a service usage acquired over a predefined period and/or an estimated future service usage.

22. The computer-implemented method according to claim 16, wherein
the updatable services comprise traffic information, navigation map updates, and/or parking space information.

23. The computer-implemented method according to claim 22, wherein
a delivery of the updatable services by the server external to the vehicle to the on-board system of the vehicle is prioritized on the basis of the service usage behavior of the vehicle user of the updatable services of the on-board system when a usage frequency of the updatable services exceeds a predefined threshold value.

24. The computer-implemented method according to claim 19, wherein
when the updatable services are not used for a predefined number of vehicle starts, a predefined operating duration of the vehicle, and/or a predefined length of a journey of the vehicle, the frequency of the delivery of the updatable services by the server external to the vehicle to the on-board system and/or the frequency of data queries of the updatable services of the on-board system to the server external to the vehicle, is reduced.

25. The computer-implemented method according to claim 16, wherein
an update radius of the data of the updatable services around the vehicle and/or covered functional road classes is adapted on the basis of the acquired data about the service usage behavior of the vehicle user of the updatable services.

26. The computer-implemented method according to claim 25, wherein
the update radius is a geographical extent covered by the data.

27. The computer-implemented method according to claim 16, wherein
the used updatable services are delivered upon each start of a new navigation route.

28. The computer-implemented method according to claim 17, wherein
the evaluation of the data about the service usage behavior of the vehicle user of the updatable services by the on-board system of the vehicle and/or the server external to the vehicle comprise a usage duration of a mode in which a navigation map is displayed, a duration for which navigation guidance is used, and/or a duration for which a full-screen map mode is used.

29. The computer-implemented method according to claim 16, wherein
the server external to the vehicle is a cloud server.

30. A system for usage-controlled service delivery to an on-board system of a vehicle, comprising:
means for acquiring data about a service usage behavior of a vehicle user of updatable services of the on-board system;
means for transmitting the data about the service usage behavior of the vehicle user of the updatable services to a cloud server external to the vehicle; and
means for delivering the updatable services to the on-board system of the vehicle by way of the server external to the vehicle on the basis of the data about the service usage behavior of the vehicle user of the updatable services.

31. A computer product comprising a computer-readable data carrier containing program code of a computer program that, when the computer program is executed on a computer, carries out the acts of:
acquiring data about a service usage behavior of a vehicle user of updatable services of the on-board system;
transmitting the acquired data about the service usage behavior of the vehicle user of the updatable services to a server external to the vehicle; and
delivering the updatable services to the on-board system of the vehicle by way of the server external to the vehicle on the basis of the acquired data about the service usage behavior of the vehicle user of the updatable services.
